(19) United States
(12) Patent Application Publication
(10) Pub. No.: US 2010/0037282 A1
(43) Pub. Date: Feb. 11, 2010

(54) DIGITAL BROADCASTING RECEIVER AND SEMICONDUCTOR INTEGRATED CIRCUIT

(75) Inventors: TAKAHIRO IWATA, Tachikawa (JP); Akira Yonekawa, Kokubunji (JP)

Correspondence Address: MILES & STOCKBRIDGE PC, 1751 PINNACLE DRIVE, SUITE 500, MCLEAN, VA, 22102-3833, US

(73) Assignee: RENESAS TECHNOLOGY CORP.

(21) Appl. No.: 12/534,139

(22) Filed: Aug. 2, 2009

(30) Foreign Application Priority Data
Aug. 6, 2008 (JP) 2008-203198

(51) Int. Cl. H04N 7/173; H04N 5/44

(52) U.S. Cl. 725/131; 348/725; 348/E05.096

(57) ABSTRACT

The digital broadcasting receiver has: a station-select control section including a station-select receiver input unit, a station-select-process control unit, and a station select information presuming unit; a transport stream (TS) information-capture unit; a decode control unit; and a data-storing unit. In response to a request for selecting a station from a user, the station-select control section sets station select information in the TS information-capture unit. In the data-storing unit, a station-select managing table is prepared, and station select information received after selecting a station is stored in the station-select managing table. The station select information contains a program title datum and more than one packet identifier. In response to the action of selecting a station by a user, the station-select control section reads out more than one packet identifier from the station-select managing table, and sets them in the TS information-capture unit as station select information.

### CLAIM OF PRIORITY

The Present application claims priority from Japanese application JP 2008-203198 filed on Aug. 6, 2008, the content of which is hereby incorporated by reference into this application.

### FIELD OF THE INVENTION

The present invention relates to a digital broadcasting receiver and a semiconductor integrated circuit (IC) used therein. Particularly, it relates to a technique useful for making it easier for a user to perform an operation to select a station on an input device, which is necessary for selecting a station broadcasting a program that the user desires to watch.

### BACKGROUND OF THE INVENTION

In the digital broadcasting, which is coming into widespread use at present, various types of additional broadcast data in addition to video and audio elementary streams are multiplexed and broadcasted. An example of the additional broadcast data is EPG (Electronic Program Guide), which is included in EIT (Event Information Table). Further, EIT contains accompanying information pieces, e.g. the start time, length, title, performer's name and genre of each program.

Therefore, a digital broadcasting receiver operable to accept a digital broadcast has a function for receiving and utilizing additional broadcast data.

JP-A-2006-50455 discloses one of such digital broadcasting receivers. To quickly cope with the changes in arrangement and content of a program guide of a broadcast station owing to extension of a televised program, insertion of an extraordinary program and the like, the digital broadcasting receiver is formed so that it determines, based on a history of a user having watched programs, a broadcast station which holds more programs that the user is interested in and whose program the user watches more frequently, conducts an EPG scan in an order depending on the result of the determination, and displays resultant EPG information.

### SUMMARY OF THE INVENTION

Prior to the invention, the inventors have been engaged in the research and development of a digital broadcasting receiver which sophisticatedly uses various types of additional broadcast data, such as EPG.

After examination of the technique described in JP-A-2006-50455, the inventors found that the digital broadcasting receiver disclosed by JP-A-2006-50455 can shorten the time required for displaying a program guide based on EPG information of a broadcast station whose programs a user concerned views frequently even after the changes in arrangement and content of the program guide of the broadcast station, but it cannot shorten a station-selecting time for selecting a station broadcasting a program that the user desires to watch.

Especially recent digital television broadcasting receivers differ from analog television broadcasting receivers remarkably, and they have not only the function of receiving three kinds of digital broadcasts, i.e. terrestrial, BS and CS digital broadcasts, through RF interfaces, but also the function of receiving an IP network digital broadcast through Ethernetwork interface.

After the examination, the inventors found that a digital broadcasting receiver with its broadcast-receiving function remarkably sophisticated like this has the problem that a button of an input device, e.g. a remote controller, needs to be operated many times for selecting a station broadcasting a program that a user concerned desires to watch, which is troublesome. Also, the examination by the inventors clearly showed that a digital broadcasting receiver with a sophisticated broadcast-receiving function, which allows even a user of advanced age to easily perform an operation of an input device required for selecting a station broadcasting a program that the user desires to watch, has been called for as a result of the arrival of a real graying society.

The invention was made after the prior study and examination by the inventor and others as described above. Therefore, it is an object of the invention to provide a digital broadcasting receiver easy for a user to perform an operation to select a broadcast station on an input device, which is necessary for selecting a station broadcasting a program that the user desires to watch.

The above and other objects of the invention and novel features thereof will become clear from the description hereof and the accompanying drawings.

Now, a preferred embodiment of the invention herein disclosed will be briefly described below.

A digital broadcasting receiver (1) according to a preferred embodiment of the invention includes: a station-select control section (101, 105, 106); a transport stream information-capture unit (107); a decode control unit (108); and a data-storing unit (102).

The transport stream information-capture unit (107) is supplied with transport streams of a received program. The station-select control section (101, 105, 106) responds to a request for selecting a station by a user, and sets the station select information in the transport stream information-capture unit (107). The transport stream information-capture unit (107) selectively captures transport streams of selected station's program information specified by the station select information.

The station-select control section (101, 105, 106) prepares a station-select managing table (103) in the data-storing unit (102), and stores station select information received after selecting a station in the station-select managing table (103) as selected station's program information. The station select information stored in the station-select managing table (103) contains a program title datum (1031), and packet identifiers (1032-1035) associated with a program from selected station's program information.

In response to station select information input by a user concerned, the station-select control section (101, 105, 106) reads out packet identifiers (1032-1035) from the station-select managing table (103), and sets it in the transport stream information-capture unit (107) as station select information.

An effect brought about by a digital broadcasting receiver according to a preferred embodiment of the invention is as follows in brief. The invention can offer a digital broadcasting receiver easy for a user to perform an operation to select a broadcast station on an input device, which is necessary for selecting a station broadcasting a program that the user desires to watch.

### BRIEF DESCRIPTION OF THE DRAWINGS

FIG. 1 is a block diagram for explaining a configuration of a digital broadcasting receiver according to an embodiment of the invention;

FIG. 2 is a flow chart showing steps of a high-speed station-selecting method executed in the digital broadcasting receiver according to the embodiment of the invention shown in FIG. 1;

FIG. 3 is a diagram showing a structure of a program title/station select information managing table in a data-storing unit of the digital broadcasting receiver according to the embodiment of the invention shown in FIG. 1;

FIG. 4 is a diagram showing another structure of the program title/station select information managing table in the data-storing unit of the digital broadcasting receiver according to the embodiment of the invention shown in FIG. 1;

FIG. 5 is a flow chart showing steps of a high-speed station-selecting method executed in a case that the data-storing unit of the digital broadcasting receiver according to the embodiment of the invention shown in FIG. 1 contains a program title/station select information managing table as shown in FIG. 4; and

FIG. 6 is a diagram showing a configuration of a semiconductor IC formed as a high-functionality system LSI having an operating function basically the same as that of the digital broadcasting receiver in the various aspects cited above.

### DETAILED DESCRIPTION OF THE PREFERRED EMBODIMENTS

### 1. Summary of the Preferred Embodiments

First, the preferred embodiments herein disclosed will be outlined. Here, the reference numerals and characters for reference to the drawings, which are accompanied with paired round brackets, only exemplify what the concepts of components and elements referred to by the numerals and characters contain.

[1] A digital broadcasting receiver (1) according to a preferred embodiment of the invention includes: a station-select control section (101, 105, 106); a transport stream information-capture unit (107); a decode control unit (108); and a data-storing unit (102).

The transport stream information-capture unit (107) is supplied with transport streams (TS) of program information containing coded video and audio signals of a broadcast program received by a tuner (201, 202).

The station-select control section (101, 105, 106) sets station select information in the transport stream information-capture unit (107) in response to a request for selecting a station from an input device subjected to an operation to select the station by a user.

The transport stream information-capture unit (107) selectively captures, from among the transport streams of the program information supplied thereto, a transport stream accordant with selected station's program information specified by the station select information, and supplies the transport stream accordant with the selected station's program information thus captured to the decode control unit (108).

The station-select control section (101, 105, 106) prepares a station-select managing table (103) in the data-storing unit (102).

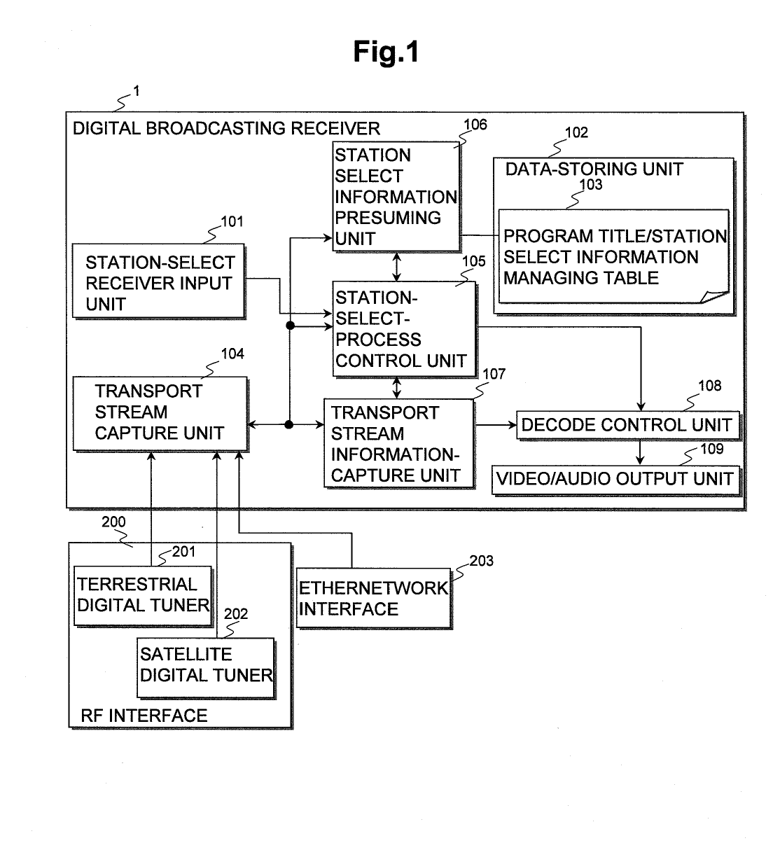

The station-select control section stores, in the station-select managing table (103) of the data-storing unit (102), the station select information selected and received by setting the station select information in the transport stream information-capture unit (107) as the selected station's program information (see FIG. 1).

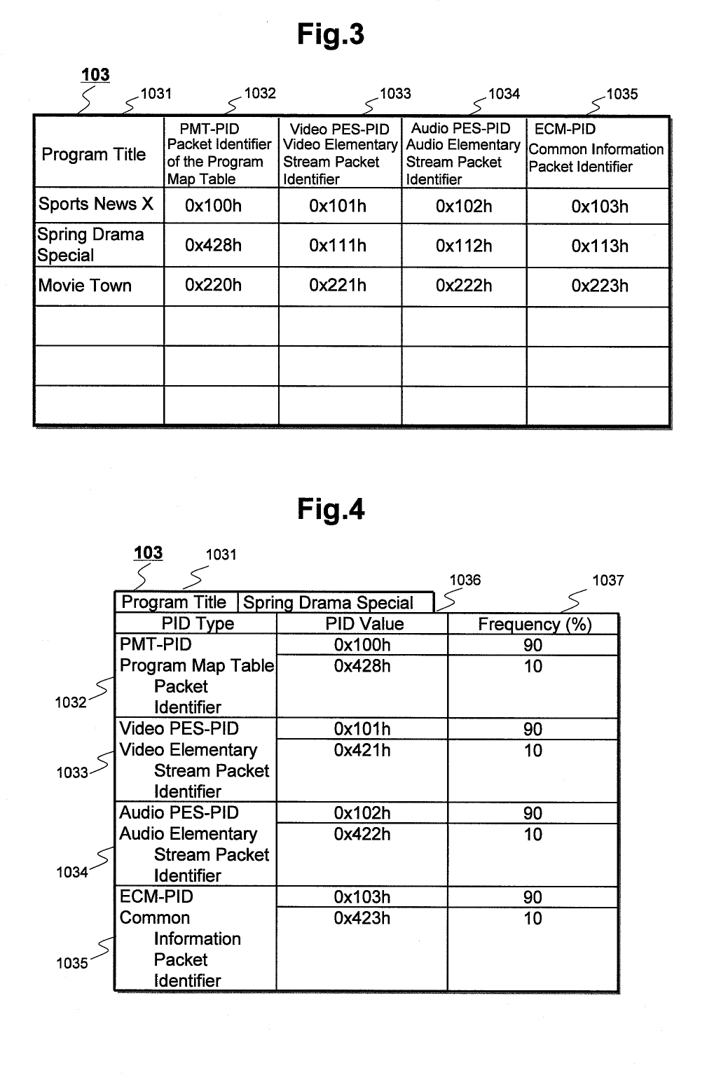

The station select information corresponding to the selected station's program information stored in the station-select managing table (103) of the data-storing unit (102) contains a program title datum (1031) associated with a program title from the selected station's program information, and more than one packet identifier (1032-1035) associated with the program from the selected station's program information (see FIG. 3).

The station-select control section (101, 105, 106) reads out the more than one packet identifier (1032-1035) stored in the station-select managing table (103) therefrom in response to station select input information pertaining to the program title of the selected station's program information and entered by an operation of the input device to select a station by the user.

The station-select control section (101, 105, 106) sets, as the station select information, the more than one packet identifier (1032-1035) read out from the station-select managing table (103) in the transport stream information-capture unit (107) (see FIGS. 1 to 3).

According to the above embodiment, as to selected station's program information which had been received as a result of a station selection of the past, more than one packet identifier (1032-1035) pertaining to a program from the selected station's program information is stored in the station-select managing table (103) of the data-storing unit (102) together with a program title datum (1031) accordant to the selected station's program information.

Hence, in an operation of an input device to select a broadcast station by a user, it suffices to just input a program title datum of selected station's program information for a program, which the user had received in the past, but desires to watch even now. On the entry of a program title datum by the user, packet identifiers (1032-1035) of selected station's program information corresponding to the program title datum are automatically set in the transport stream information-capture unit (107) from the station-select managing table (103). Thus, a user operation on an input device to select a broadcast program that the user desires to watch can be made easier.

In the digital broadcasting receiver according to a preferred embodiment, the station select input information entered by the user as an input for search for reading out the more than one packet identifier (1032-1035) from the station-select managing table (103) contains at least an important character datum incorporated in the program title of the selected station's program information.

In the digital broadcasting receiver according to a more preferred embodiment, the more than one packet identifier includes a packet identifier (1032) of a program map table (PMT), and in the program map table, packet identifiers of transport streams conveying coded signals constituting a program of the selected station's program information are entered (see FIG. 3).

In the digital broadcasting receiver according to a still more preferred embodiment, the more than one packet identifier further includes a packet identifier (1033) of a video elementary stream, and a packet identifier (1034) of an audio elementary stream, and the video and audio elementary streams constitute a program of the selected station's program information (see FIG. 3).

In the digital broadcasting receiver according to a specific embodiment, the more than one packet identifier further includes a packet identifier (1035) of common information (ECM) necessary for a limited-receive system (CAS) (see FIG. 3).

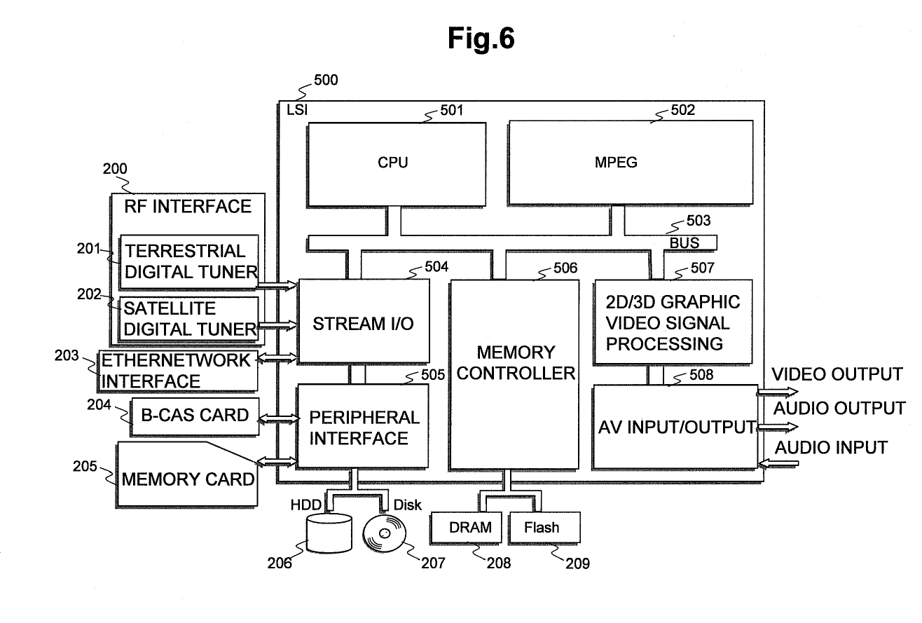

In the digital broadcasting receiver according to a most specific embodiment, the data-storing unit (102) is composed of one of a magnetic storage device usable for accumulating contents of a received digital broadcast, and a non-volatile semiconductor memory for storing an operation program for a semiconductor integrated circuit built in the digital broadcasting receiver (see FIG. 6).

[2] Provided according to a preferred embodiment of the invention from another aspect thereof is a semiconductor IC applied to a digital broadcasting receiver which includes a station-select control section, a transport stream information-capture unit, a decode control unit and a data-storing unit.

The transport stream information-capture unit is supplied with transport streams of program information containing coded video and audio signals of a broadcast program received by a tuner.

The station-select control section sets station select information in the transport stream information-capture unit in response to a request for selecting a station from an input device subjected to an operation to select the station by a user.

The transport stream information-capture unit selectively captures, from among the transport streams of the program information supplied thereto, a transport stream accordant with selected station's program information specified by the station select information, and supplies the transport stream accordant with the selected station's program information thus captured to the decode control unit.

The station-select control section prepares a station-select managing table in the data-storing unit.

The station-select control section stores, in the station-select managing table of the data-storing unit, the station select information selected and received by setting the station select information in the transport stream information-capture unit as the selected station's program information (see FIG. 1).

The station select information corresponding to the selected station's program information stored in the station-select managing table of the data-storing unit contains a program title datum associated with a program title from the selected station's program information, and more than one packet identifier associated with the program from the selected station's program information.

The station-select control section reads out the more than one packet identifier stored in the station-select managing table therefrom in response to station select input information pertaining to the program title of the selected station's program information and entered by an operation of the input device to select a station by the user.

The station-select control section sets, as the station select information, the more than one packet identifier read out from the station-select managing table in the transport stream information-capture unit (see FIGS. 1 to 3).

Into a semiconductor IC (500), at least a central processing unit (501), a MPEG video decoding engine (502) and a transport stream I/O unit (504) are integrated.

The central processing unit (501) has the same operating function as that of the station-select control section (101, 105, 106); the transport stream I/O unit (504) has the same operating function as that of the transport stream information-capture unit (107); and the MPEG video decoding engine (502) has the same operating function as that of the decode control unit (108), for which see FIG. 6.

### 2. Further Detailed Description of the Preferred Embodiments

Now, the embodiments will be described further in detail. It is noted that in all the drawings for explanation of the best forms for embodying the invention, members or parts having identical functions are identified by the same reference numeral or character, and the repeated description thereof is omitted.

### <<Configuration of Digital Broadcasting Receiver>>

FIG. 1 is a block diagram for explaining a configuration of a digital broadcasting receiver 1 according to an embodiment of the invention.

The digital broadcasting receiver 1 of FIG. 1 has a data-storing unit operable to keep station select information for selecting a station with a shortened time involved in selecting a broadcast station while utilizing program information sent out from a broadcast station by digital broadcast.

Specifically, the digital broadcasting receiver 1 of FIG. 1 includes: a station-select receiver input unit 101; a data-storing unit 102; a program title/station select information managing table 103; a transport stream capture unit 104; a station-select-process control unit 105; a station select information presuming unit 106; a transport stream information-capture unit 107; a decode control unit 108; and a video/audio output unit 109.

The station-select receiver input unit 101 is supplied with a request for selecting a station broadcasting a program in the form of an infrared input signal according to up-down or direct selecting means, in which the request is input by a user pressing down a button on an input device, e.g. a remote controller, connected with the digital broadcasting receiver 1. The station-select receiver input unit 101 converts infrared input signals into electric signals of station select information. The resultant station select information is supplied to the station-select-process control unit 105.

The transport stream capture unit 104 is connected with an RF interface 200 of a terrestrial digital tuner 201 for receiving a terrestrial digital broadcast, which is a full-segment high-definition broadcast, and a satellite digital tuner 202 for receiving a satellite digital broadcasts of BS digital broadcast and CS digital broadcast. The transport stream capture unit 104 is further connected with an Ethernetwork interface 203, such as NIC (Network Interface Card), for receiving a digital broadcast from an IP network. Now, it is noted that RF is an abbreviation for “Radio Frequency”, and IP for “Internet Protocol”. A transport stream is defined by MPEG system standard. In other words, in digital broadcasting, transport streams (TS) represent data streams produced by multiplexing program information pieces converted in e.g. coded video signals, audio signals and section forms. Incidentally, MPEG is an abbreviation for “Moving Picture Experts Group”, and TS for “Transport Stream”.

The transport stream information-capture unit 107 is supplied with station select information containing various packet identifiers (PIDs) from the station-select-process control unit 105, which is to be described later. Then, the transport stream information-capture unit 107 captures respective sections' information and video and audio packets fitting packet identifiers (PIDs) contained in the specified station select information from among transport streams supplied from the transport stream capture unit 104 by means of filtering, and supplies video and audio packets thus captured to the decode control unit 108. Now, it is noted that PID is an abbreviation for “Packet Identifier”.

The decode control unit 108 decodes coded video and audio packets supplied from the transport stream information-capture unit 107, and provides the resultant video and audio signals to the video/audio output unit 109. Also, the decode control unit 108 controls the output of video and audio signals to the video/audio output unit 109 according to designations of the video output timing and audio output timing supplied from the station-select-process control unit 105.

The video/audio output unit 109 displays decoded video and audio frames output by the decode control unit 108 as a moving picture. For outputs of video and audio, video and audio output devices or an integration of them, e.g. a display monitor and speaker accompanying the digital broadcasting receiver 1, may be used. Alternatively, video and audio output devices accompanying another device different from the digital broadcasting receiver 1 can be used by means of communication through a home network or the like.

A magnetic storage device built in the digital broadcasting receiver 1 may be used as the data-storing unit 102. An example of such magnetic storage device is HDD (Hard Disk Drive) used to accumulate various types of contents of a received digital broadcast. Other than that, a non-volatile semiconductor memory, such as a flash memory storing various operation programs for a built-in LSI of the digital broadcasting receiver 1, can be used for the data-storing unit 102. Particularly, the data-storing unit 102 has therein the program title/station select information managing table 103, and in the managing table, station select information about a broadcast program that the digital broadcasting receiver 1 received in the past is stored.

### <<Selected Station's Information Stored in the Program Title/Station Select Information Managing Table>>

The following types of station select information are stored in the program title/station select information managing table 103.

The first type of station select information is a program title datum contained in an EIT of EPG captured by the station-select-process control unit 105 during a period of past reception. Specifically, an EIT contains accompanying information pieces, e.g. the start time, length, title, performer's name and genre of each program. Now, it is noted that EIT is an abbreviation for “Event Information Table”.

The second type of station select information is a packet identifier (PID) of a program map table, which is abbreviated as “PMT”. PMT is a table which contains: a packet identifier (PID) of TS packets carrying coded signals constituting a program; and an identifier (PID) of packets conveying common information of pay-broadcast-related information. The action of selecting a station that a user performs represents the step of acquiring this table from signals output by a tuner. Hence, PMT is regarded as one of the most important tables in digital broadcasting.

Packet identifiers (PIDs) of video and audio elementary streams forming a program are stored in the program title/station select information managing table 103 corresponding to a program title datum, which accompany a packet identifier (PID) of PMT.

The third type of station select information stored in the program title/station select information managing table 103 corresponding to a program title datum is a packet identifier (PID) of common information (ECM) necessary for a limited-receive system (CAS). The limited-receive system referred to as “conditional access system (CAS)” is a system which scrambles or encrypts broadcast program information, and controls program watching by subscribers so that the subscribers can receive only a program which they are allowed to watch, namely they have contracted for watching. As to a program controlled in subscribers' program watching, the video, audio and data of the program are scrambled before being sent out, and only authorized subscribers can descramble them. The subscribers' program watching is controlled in this way. Program-watching criteria of programs make common information termed ECM, and are carried to respective receivers by broadcasting waves. Details of subscribers' contracts form common information termed EMM, and are carried to individual receivers by broadcasting waves. Each receiver can be identified by the identification number of an IC card supplied therewith. Subscriber's contract detail information of EMM is written into the IC card. Whether or not to permit the program watching is determined according to a program-watching criterion of ECM and a subscriber's contract detail held in the IC card. In this way, unscrambling by the receiver is controlled. For such IC card, a B-CAS card is used commonly to BS digital broadcasting and terrestrial digital broadcasting. Now, it is noted that CAS is an abbreviation for “Conditional Access System”, ECM for “Entitlement Control Message”, and EMM for “Entitlement Management Message”.

### <<Operation to Select a Broadcast Station by the Digital Broadcasting Receiver>>

In response to station select information which a user has input to the station-select receiver input unit 101, the station-select-process control unit 105 issues the station select information presuming unit 106 with a request for presumption of station select information for a program whose station is likely to be selected. Then, based on station select information supplied from the station-select-process control unit 105, the station select information presuming unit 106 searches for station select information stored in the program title/station select information managing table 103 of the data-storing unit 102. In this search, a program title datum, which is a piece of station select information, is used as input information for search. As results of the search, four packet identifiers (PIDs), i.e. a packet identifier of a program map table (PMT), packet identifiers of video and audio elementary streams, which form a program, and a packet identifier of common information (ECM) necessary for a limited-receive system (CAS) are output from the program title/station select information managing table 103.

On the other hand, a receive transport stream supplied from the transport stream capture unit 104 contains a latest program association table (PAT). The program association table (PAT) is one in which packet identifiers (PIDs) of TS packets carrying a program map table (PMT) are entered. Specifically, the station select information presuming unit 106 compares the packet identifier (PID) of a program map table (PMT) contained in the latest program association table (PAT) with the packet identifier (PID) of a program map table (PMT) as station select information stored in the program title/station select information managing table 103 at a time of past reception, thereby to verify whether they are in agreement with each other. After the verification, in a case that packet identifiers (PIDs) of both the program map tables (PMTs) are in agreement with each other, the station select information presuming unit 106 presumes that transport streams of a program which the user desires to receive are being supplied from the transport stream capture unit 104 at present. According to the result of presumption, together with the packet identifier (PID) of the program map table (PMT), with which the agreement has been verified, packet identifiers of video and audio elementary streams forming the program, and a packet identifier of common information (ECM) necessary for a limited-receive system (CAS) are set in the transport stream information-capture unit 107 through the station-select-process control unit 105. Now, it is noted that PAT is an abbreviation for “Program Association Table”.

After setting the four types of packet identifiers (PIDs), the transport stream information-capture unit 107 captures respective sections' information and video and audio packets fitting the packet identifier (PID) of the program map table (PMT), which has been set, from among transport streams supplied from the transport stream capture unit 104 by means of filtering, and supplies video and audio packets thus captured to the decode control unit 108.

### <<Structure of the Program Title/Station Select Information Managing Table>>

FIG. 3 is a diagram showing a structure of the program title/station select information managing table 103 in the data-storing unit 102 of the digital broadcasting receiver 1 shown in FIG. 1.

In the program title/station select information managing table 103 of FIG. 3, more than one program title data contained by an event information table (EIT) of an electronic program guide system (EPG) can be stored in the first program title entry 1031. In the second entry 1032 of the table 103, the packet identifier (PID) of more than one program map table (PMT) can be stored corresponding to more than one program. In the third entry 1033 and fourth entry 1034 of the table 103, the packet identifiers (PIDs) of video elementary streams and the packet identifiers (PIDs) of audio elementary streams, which constitute programs, can be stored corresponding to the programs. Finally, the packet identifier (PID) of common information (ECM) necessary for the limited-receive system (CAS) can be stored in the fifth entry 1035 of the table 103 corresponding to each program.

### <<High-Speed Station-Selecting Method>>

Next, a method of selecting a station at a high speed will be described, in which a program title contained in program information is utilized to shorten the time involved in selecting a broadcast station.

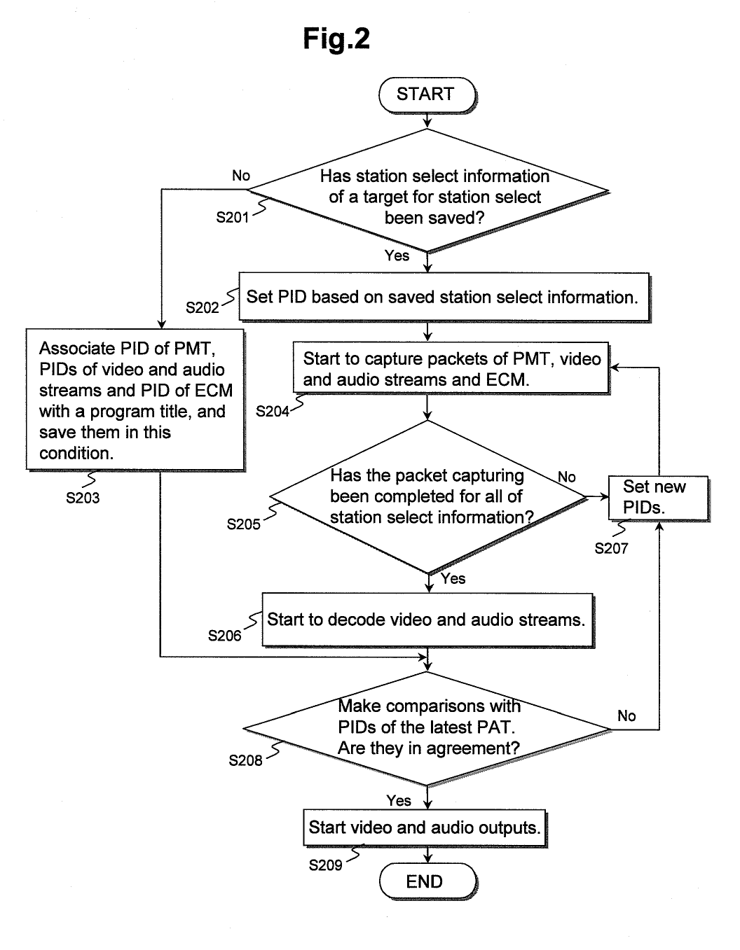

FIG. 2 is a flow chart showing the steps of the high-speed station-selecting method executed in the digital broadcasting receiver 1 shown in FIG. 1. The steps of the high-speed station-selecting method will be described below with reference to FIG. 2.

In Step S201, in response to station select information, which a user has input to the station-select receiver input unit 101, the station-select-process control unit 105 supplies the station select information presuming unit 106 with a program title as station select information, and in parallel, issues the station select information presuming unit 106 with a request for presumption of station select information for a program whose station is likely to be selected.

Then, based on a televised program's title, which is station select information, the station select information presuming unit 106 searches for, as station select information pieces, the program title datum, the packet identifier (PID) of a program map table (PMT), packet identifiers (PIDs) of video and audio elementary streams constituting the program, and the packet identifier (PID) of common information (ECM) necessary for the limited-receive system (CAS); these are stored in the program title/station select information managing table 103 of the data-storing unit 102. Further in Step S201, the acquisition of the latest program association table (PAT) containing the program map table (PMT) of the televised program for which the managing table 103 is searched is started in parallel with searching the program title/station select information managing table 103 based on the title of a televised program, which is station select information.

In a case that the information about a candidate station which is likely to be selected is output from the program title/station select information managing table 103 as a result of searching the program title/station select information managing table 103 using a program title as a search key in Step S201, Step S202 is put into execution. However, in a case that as a result of searching the program title/station select information managing table 103 using a program title as a search key in Step S201, the information about a candidate station which is likely to be selected is not output from the program title/station select information managing table 103, Step S203 is put into execution.

In Step S202, the packet identifier (PID) of the program map table (PMT), the packet identifier (PID) of video elementary streams and the packet identifier (PID) of audio elementary streams, which constitute the program, and the packet identifier (PID) of common information (ECM) necessary for the limited-receive system (CAS), which are station select information pieces output as results of the search of the program title/station select information managing table 103 by the station select information presuming unit 106, are set in the transport stream information-capture unit 107 by the station-select-process control unit 105 as they are. Sometimes one digital broadcast program includes more than one service. In such case, a user can select, from among combinations of video and audio signals, an appropriate one by operating a remote controller. Incidentally, the more than one service is described in SI (Service Information), which is referred to as SDT (Service Description Table). Therefore, in addition to the program map table (PMT) serving as a table which contains a packet identifier (PID) of TS packets carrying coded signals which constitute a program, the packet identifiers (PIDs) of video and audio elementary streams forming the program are stored in the program title/station select information managing table 103.

In subsequent Step S204, the transport stream information-capture unit 107 starts to capture, from among various transport streams supplied from the transport stream capture unit 104, transport stream packets containing packet identifiers (PIDs) in agreement with the four types of packet identifiers (PIDs) which have been set by the station-select-process control unit 105 in Step S202. In other words, transport stream packets captured by the transport stream information-capture unit 107 are classified in four types, i.e. a transport stream packet of a program map table (PMT), a transport stream packet of video, a transport stream packet of audio, and a transport stream packet of common information (ECM) necessary for the limited-receive system (CAS) which are station select information.

In subsequent Step S205, it is checked whether respective packets are captured properly in capture of the four types of transport stream packets started by the transport stream information-capture unit 107 in Step S204. The checking of Step S205 is a relatively simple step in which a check is made about whether the four types of transport stream packets contain the data. The reasons why Step S205 is so arranged areas follows. The first reason is that another stricter check will be made in later Step S208. The second reason is that it is necessary to begin earlier the process of decoding video and audio elementary streams of Step S206, in which a large amount of data is handled, to execute real time MPEG decoding.

Therefore, in a case that it is confirmed as a result of the relatively simple check in Step S205 that respective packet captures are conducted properly in capture of transport stream packets by the transport stream information-capture unit 107 which has started in Step S204, the step of decoding videos and audios of Step S206 is put into execution.

However, if it is confirmed from the relatively simple check in Step S205 that respective packet captures are not conducted properly, it is a reality that station select information stored in the program title/station select information managing table 103 at time of past reception has become outdated, and a new broadcast program corresponding to the old station select information stored in the program title/station select information managing table 103 is not broadcasted at present. In this case, Step S207 is put into execution. In Step S207, a new program map table's packet identifier (PMT-PID) stated in the latest program map table (PMT) included in the latest program association table (PAT), the capture of which is started in Step S201, new packet identifiers (PIDs) of video and audio elementary streams constituting a program, and a new packet identifier (PID) of common information (ECM) necessary for the limited-receive system (CAS) are set in the transport stream information-capture unit 107.

Now, it is noted that the station select information set in the transport stream information-capture unit 107 is the station select information of a broadcast program having the same title as that of a broadcast program whose station the user desires to select or having a title very similar thereto. On reception of a broadcast program according to the new settings of the transport stream information-capture unit 107, the station select information of the broadcast program is stored in the program title/station select information managing table 103, and therefore the station-selecting time for a subsequent broadcast program and later one can be shortened.

In Step S206 in which videos and audios are decoded, transport streams of a program captured by the transport stream information-capture unit 107, and a descrambling key are supplied to the decode control unit 108. Then, the decode control unit 108 descrambles and decodes packets of video and audio elementary streams of a program of a selected station.

In Step S208, it is checked strictly whether the capture of four types of transport stream packets started by the transport stream information-capture unit 107 in Step S204 are properly executed. If the packets are captured properly, correct video and audio data can be output to the video/audio output unit 109 in the subsequent Step S209. However, if the packets are not captured properly, the scrambled program information cannot be descrambled, or in the subsequent Step S209, abnormal video and audio data will be output to the video/audio output unit 109.

Such abnormal condition is owing to the disagreement between packet identifiers (PIDs) contained in four types of transport streams gained in capture of packets by the transport stream information-capture unit 107 in Step S204, and the four types of packet identifiers (PIDs) set in the transport stream information-capture unit 107 by the station-select-process control unit 105 in Step S202. The four types of packet identifiers (PIDs) set in the transport stream information-capture unit 107 by the station-select-process control unit 105 in Step S202 are four types of packet identifiers (PIDs) of the past, which were output in searching the program title/station select information managing table 103 by the station select information presuming unit 106.

The disagreement between the four types of packet identifiers (PIDs) of the past output by the station select information managing table 103 in Step S202, and four types of new packet identifiers (PIDs) captured by the transport stream information-capture unit 107 in Step S204 is owing to e.g. the management by a broadcast station offering a broadcast program of interest. Even with a targeted broadcast program unchanged, the change or modification in program arrangement on the side of a broadcast station, for instance, can cause four types of packet identifiers (PIDs) of the program map table (PMT), video and audio elementary streams, and common information (ECM) necessary for the limited-receive system (CAS) to be replaced with new ones. Therefore, after such change or modification, in a case that old packet identifiers (PIDs) of the past are used in receiving the same broadcast program, abnormal video and audio data will be output to the video/audio output unit 109 in Step S209.

Hence, in a case that a disagreement on four types of packet identifiers (PIDs) is detected in Step S208, Step S207 is put into execution. In Step S207, four types of new packet identifiers (PIDs) contained in the latest program map table (PMT) included in the latest program association table (PAT), the capture of which is started in Step S201, are set in the transport stream information-capture unit 107, provided that the four types of new packet identifiers (PIDs) consist of a packet identifier of a program map table (PMT), packet identifiers of video and audio elementary streams and a packet identifier of a common information (ECM) necessary for the limited-receive system (CAS). On receipt of a broadcast program according to the setting of new station select information of the transport stream information-capture unit 107, the station select information of the broadcast program is stored in the program title/station select information managing table 103. Thus, the station-selecting time of a broadcast program of next or later time can be shortened.

On the other hand, the title of a broadcast program of station select information, which had not stored in the program title/station select information managing table 103 of the data-storing unit 102 in a receiving action of the past, and four types of new packet identifiers (PIDs) of a program map table (PMT) corresponding to the program title, a video elementary stream, an audio elementary stream and common information (ECM) necessary for the limited-receive system (CAS) are stored in the program title/station select information managing table 103 of the data-storing unit 102 in Step S202.

### <<Another Structure of the Program Title/Station Select Information Managing Table>>

FIG. 4 is a diagram showing another structure of the program title/station select information managing table 103 in the data-storing unit 102 of the digital broadcasting receiver 1 shown in FIG. 1.

Unlike the program title/station select information managing table 103 of FIG. 3, the program title/station select information managing table 103 shown in FIG. 4 has a first program title entry 1031, and a second entry 1032, a third entry 1033, a fourth entry 1034 and a fifth entry 1035, which correspond to the first entry 1031, and each includes a plurality of columns corresponding to different frequencies of use. Therefore, the program title/station select information managing table 103 shown in FIG. 4 is arranged so that four types of packet identifiers (PIDs) of program map tables (PMTs) of different broadcast programs having a common program title, but differing in using frequency based on the number of times a user watches, video and audio elementary streams forming the programs, common information (ECM) necessary for the limited-receive system (CAS) can be stored therein.

In the example of the program title/station select information managing table 103 shown in FIG. 4, even in a case that the first and second programs are identical in program title, four types of packet identifiers (PIDs) of the first broadcast program having a using frequency of 90%, and four types of packet identifiers (PIDs) of the second broadcast program having a using frequency of 10% can be stored.

### <<Another High-Speed Station-Selecting Method>>

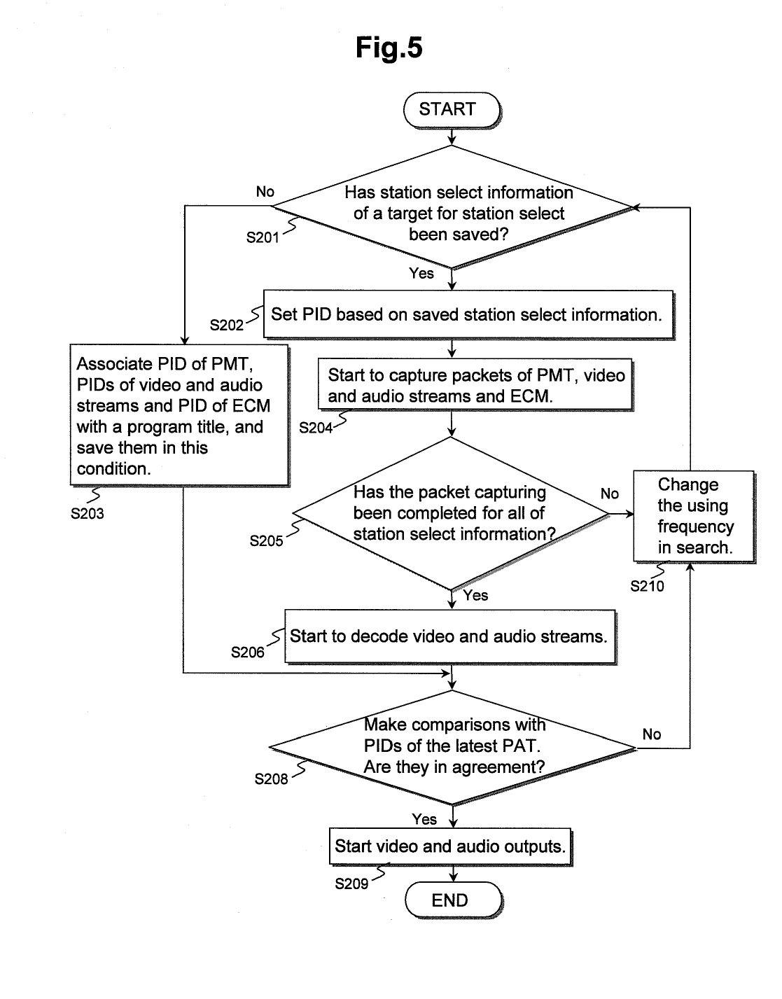

FIG. 5 is a flow chart showing steps of a high-speed station-selecting method executed in a case that the data-storing unit 102 of the digital broadcasting receiver 1 shown in FIG. 1 contains a program title/station select information managing table 103 as shown in FIG. 4.

The steps of the high-speed station-selecting method shown in FIG. 5 will be described below focusing on the differences from the high-speed station-selecting method shown in FIG. 2.

In the high-speed station-selecting method shown in FIG. 5, Step S210 including changing a frequency of use for search replaces Step S207 of the high-speed station-selecting method shown in FIG. 2, which includes setting new packet identifiers (PIDs). After Step S210 of FIG. 5, the processing flow shifts to Step S201. Other steps of the high-speed station-selecting method shown in FIG. 5 are the same as those of the high-speed station-selecting method of FIG. 2.

In other words, in the high-speed station-selecting method shown in FIG. 5, Step S210 is put into execution in a case that it is confirmed from the relatively simple check in Step S205 that respective packet captures are not conducted properly, or a case that a disagreement on four types of packet identifiers (PIDs) is detected in Step S208. Specifically, in Step S210 of FIG. 5, the frequency of use is lowered by one level for search of the program title/station select information managing table 103 in Step S201 of FIG. 5.

Then, as a result of search of the program title/station select information managing table 103 using a program title as a search key in Step S201 of FIG. 5, the information of a station select target having a frequency of use lower by one level is output from the program title/station select information managing table 103. Thereafter, Step S202 is put into execution.

In Step S202 of FIG. 5, the station-select-process control unit 105 sets four types of packet identifiers (PIDs) of a program map table (PMT), video and audio elementary streams and common information (ECM) necessary for the limited-receive system (CAS) in the transport stream information-capture unit 107 as they are, which are information of a station select target having a one-level-lower frequency of use, which is output as a result of search of the program title/station select information managing table 103.

According to the above-described embodiment, even in a case that no packet has been captured by use of station select information saved in the program title/station select information managing table 103 in the past, a packet identifier (PID) which is the second highest in the frequency of use and which corresponds to the same broadcast program title is set again. Thus, the probability of successfully capturing transport stream packets at a time of receiving a broadcast can be increased.

### <<High-Functionality System LSI for Digital Television Broadcasting Receivers>>

FIG. 6 is a diagram showing a configuration of a semiconductor IC formed as a high-functionality system LSI having an operating function basically the same as that of the digital broadcasting receiver 1 in the various aspects cited above.

Into the semiconductor chip of the semiconductor IC 500 formed as the high-functionality system LSI shown in FIG. 6 are integrated: a CPU (Central Processing Unit) 501; a MPEG video decoding engine 502; a bus 503; a transport stream I/O unit 504; a peripheral interface unit 505; a memory controller 506; a 2D/3D graphic video signal processing unit 507; and a video/audio I/O unit 508.

The transport stream I/O unit 504 is arranged so that an RF interface 200 which includes a terrestrial digital tuner 201 and a satellite digital tuner 202, and is located outside the semiconductor IC 500, and an Ethernetwork interface 203 for receiving a digital broadcast through an IP network can be connected thereto. The peripheral interface unit 505 is arranged to be connectable with a B-CAS card 204 into which pieces of contract detail information EMM of individual subscribers are written for controlling a descrambling action by the receiver. Further, a removable flash memory card 205, a HDD magnetic storage device 206, and a DVD recording device 207 can be connected with the peripheral interface unit 505. Incidentally, HDD stands for Hard Disk Drive. Moreover, a large-capacity, high-speed dynamic random access memory (DRAM) 208 and a large-capacity non-volatile semiconductor flash memory 209 can be connected to the memory controller 506.

The data-storing unit 102 holding the program title/station select information managing table 103 as described with reference to FIG. 1 can be built in one of the HDD magnetic storage device 206 and non-volatile semiconductor flash memory 209, which can be connected with the semiconductor IC 500.

The CPU 501 refers to subscribers' contract detail information EMM written in the B-CAS card 204, and in parallel, searches the program title/station select information managing table 103 prepared in one of the HDD magnetic storage device 206 and non-volatile semiconductor flash memory 209, which makes it possible to select a station at a high speed. In other words, CPU 501 has the same operating functions as those of the station-select-process control unit 105 and station select information presuming unit 106 of the digital broadcasting receiver 1 shown in FIG. 1, and sets, as station select information, four types of identifiers (PIDs) gained as results of search of the program title/station select information managing table 103 prepared in one of the HDD magnetic storage device 206 and non-volatile semiconductor flash memory 209 in the transport stream I/O unit 504.

Thus, it becomes possible to extract, from among many digital broadcasts received through the RF interface 200 or Ethernetwork interface 203, decoded video and audio elementary streams of a broadcast program that the user desires to watch with the transport stream I/O unit 504. In other words, the transport stream I/O unit 504 has the same operating functions as those of the transport stream capture unit 104 and transport stream information-capture unit 107 included in the digital broadcasting receiver 1 of FIG. 1. The decoded video and audio elementary streams thus extracted are transferred from the transport stream I/O unit 504 to the MPEG video decoding engine 502, and then a high-speed, real-time MPEG decode is executed by the MPEG video decoding engine 502. The decoded video and audio signals formed by the MPEG video decoding engine 502 as a result of that are processed by the 2D/3D graphic video signal processing unit 507, and then transferred to the video/audio I/O unit 508. As described above, the MPEG video decoding engine 502 has the same operating function as that of the decode control unit 108 included in the digital broadcasting receiver 1 of FIG. 1.

While the invention made by the inventor has been described above in detail based on the embodiments, it is not so limited. It will be obvious that various changes and modifications may be made without departing from the scope thereof.

For example, the invention is not limited to an embodiment that as station select information to be stored in the program title/station select information managing table 103 of the data-storing unit 102, all the character data of broadcast programs' titles are stored corresponding to four types of new packet identifiers (PIDs) of a program map table (PMT), a video elementary stream, an audio elementary stream and common information (ECM) necessary for the limited-receive system (CAS). According to another embodiment of the invention, character data of important key words which are part of broadcast programs' titles can be stored in the program title/station select information managing table 103 of the data-storing unit 102, corresponding to the above four types of packet identifiers (PIDs).

The invention can be also applied to a Set Top Box and a personal computer having the function of receiving a terrestrial digital broadcast and the like, in addition to a digital television broadcasting receiver operable to receive transport streams based on digital television broadcasting waves.

1. A digital broadcasting receiver comprising:
a station-select control section;
a transport stream information-capture unit;
a decode control unit; and
a data-storing unit,
wherein the transport stream information-capture unit is supplied with transport streams of program information containing coded video and audio signals of a broadcast program received by a tuner,
the station-select control section sets station select information in the transport stream information-capture unit in response to a request for selecting a station from an input device subjected to an operation to select the station by a user,
the transport stream information-capture unit selectively captures, from among the transport streams of the program information supplied thereto, a transport stream accordant with selected station's program information specified by the station select information, and supplies the transport stream accordant with the selected station's program information thus captured to the decode control unit,
the station-select control section prepares a station-select managing table in the data-storing unit,
the station-select control section stores, in the station-select managing table of the data-storing unit, the station select information selected and received by setting the station select information in the transport stream information-capture unit as the selected station's program information,
the station select information corresponding to the selected station's program information stored in the station-select managing table of the data-storing unit contains a program title datum associated with a program title from the selected station's program information, and more than one packet identifier associated with the program from the selected station's program information,
the station-select control section reads out the more than one packet identifier stored in the station-select managing table therefrom in response to station select input information pertaining to the program title of the selected station's program information and entered by an operation of the input device to select a station by the user, and
the station-select control section sets, as the station select information, the more than one packet identifier read out from the station-select managing table in the transport stream information-capture unit.

2. The digital broadcasting receiver according to claim 1, wherein the station select input information input by the user as an input for search for reading out the more than one packet identifier from the station-select managing table contains at least an important character datum incorporated in the program title of the selected station's program information.

3. The digital broadcasting receiver according to claim 1, wherein the more than one packet identifier includes a packet identifier of a program map table, and
in the program map table, packet identifiers of transport streams conveying coded signals constituting a program from the selected station's program information are entered.

4. The digital broadcasting receiver according to claim 3, wherein the more than one packet identifier further includes a packet identifier of a video elementary stream, and a packet identifier of an audio elementary stream, and
the video and audio elementary streams constitute a program of the selected station's program information.

5. The digital broadcasting receiver according to claim 4, wherein the more than one packet identifier further includes a packet identifier of common information necessary for a limited-receive system.

6. The digital broadcasting receiver according to claim 5, wherein the data-storing unit is composed of one of a magnetic storage device usable for accumulating contents of a received digital broadcast, and a non-volatile semiconductor memory for storing an operation program for a semiconductor integrated circuit built in the digital broadcasting receiver.

7. A semiconductor integrated circuit which is applied to a digital broadcasting receiver comprising:
a central processing unit;
a MPEG video decoding engine; and
a transport stream I/O unit,
wherein the digital broadcasting receiver includes a station-select control section,
a transport stream information-capture unit,
a decode control unit, and
a data-storing unit,
wherein the transport stream information-capture unit is supplied with transport streams of program information containing coded video and audio signals of a broadcast program received by a tuner,
the station-select control section sets station select information in the transport stream information-capture unit in response to a request for selecting a station from an input device subjected to an operation to select the station by a user,
the transport stream information-capture unit selectively captures, from among the transport streams of the program information supplied thereto, a transport stream accordant with selected station's program information specified by the station select information, and supplies the transport stream accordant with the selected station's program information thus captured to the decode control unit,
the station-select control section prepares a station-select managing table in the data-storing unit,
the station-select control section stores, in the station-select managing table of the data-storing unit, the station select information selected and received by setting the station select information in the transport stream information-capture unit as the selected station's program information,
the station select information corresponding to the selected station's program information stored in the station-select managing table of the data-storing unit contains a program title datum associated with a program title from the selected station's program information, and more than one packet identifier associated with the program from the selected station's program information,
the station-select control section reads out the more than one packet identifier stored in the station-select managing table therefrom in response to station select input information pertaining to the program title of the selected station's program information and entered by an operation of the input device to select a station by the user, and
the station-select control section sets, as the station select information, the more than one packet identifier read out from the station-select managing table in the transport stream information-capture unit,
the central processing unit has an operating function identical to that of the station-select control section,
the transport stream I/O unit has an operating function identical to that of the transport stream information-capture unit, and
the MPEG video decoding engine has an operating function identical to that of the decode control unit.

8. The semiconductor integrated circuit according to claim 7, wherein the station select input information input by the user as an input for search for reading out the more than one packet identifier from the station-select managing table contains at least an important character datum incorporated in the program title of the selected station's program information.

9. The semiconductor integrated circuit according to claim 7, wherein the more than one packet identifier includes a packet identifier of a program map table, and
in the program map table, packet identifiers of transport streams conveying coded signals constituting a program from the selected station's program information are entered.

10. The semiconductor integrated circuit according to claim 9, wherein the more than one packet identifier further includes a packet identifier of a video elementary stream, and a packet identifier of an audio elementary stream, and
the video and audio elementary streams constitute a program of the selected station's program information.

11. The semiconductor integrated circuit according to claim 10, wherein the more than one packet identifier further includes a packet identifier of common information necessary for a limited-receive system.

12. The semiconductor integrated circuit according to claim 11, wherein the data-storing unit is composed of one of a magnetic storage device usable for accumulating contents of a received digital broadcast, and a non-volatile semiconductor memory for storing an operation program for the semiconductor integrated circuit.

13. The digital broadcasting receiver according to claim 2, wherein the more than one packet identifier includes a packet identifier of a program map table, and
in the program map table, packet identifiers of transport streams conveying coded signals constituting a program from the selected station's program information are entered.

14. The digital broadcasting receiver according to claim 13, wherein the more than one packet identifier further includes a packet identifier of a video elementary stream, and a packet identifier of an audio elementary stream, and
the video and audio elementary streams constitute a program of the selected station's program information.

15. The digital broadcasting receiver according to claim 14, wherein the more than one packet identifier further includes a packet identifier of common information necessary for a limited-receive system.

16. The digital broadcasting receiver according to claim 15, wherein the data-storing unit is composed of one of a magnetic storage device usable for accumulating contents of a received digital broadcast, and a non-volatile semiconductor memory for storing an operation program for a semiconductor integrated circuit built in the digital broadcasting receiver.

17. The semiconductor integrated circuit according to claim 8, wherein the more than one packet identifier includes a packet identifier of a program map table, and
in the program map table, packet identifiers of transport streams conveying coded signals constituting a program from the selected station's program information are entered.

18. The semiconductor integrated circuit according to claim 17, wherein the more than one packet identifier further includes a packet identifier of a video elementary stream, and a packet identifier of an audio elementary stream, and
the video and audio elementary streams constitute a program of the selected station's program information.

19. The semiconductor integrated circuit according to claim 18, wherein the more than one packet identifier further includes a packet identifier of common information necessary for a limited-receive system.

20. The semiconductor integrated circuit according to claim 19, wherein the data-storing unit is composed of one of a magnetic storage device usable for accumulating contents of a received digital broadcast, and a non-volatile semiconductor memory for storing an operation program for the semiconductor integrated circuit.
